(19) United States
(12) Patent Application Publication
(10) Pub. No.: US 2013/0347027 A1
(43) Pub. Date: Dec. 26, 2013

(54) INFORMATION OUTPUT DEVICE, INFORMATION OUTPUT METHOD, AND COMPUTER PROGRAM PRODUCT

(71) Applicant: KABUSHIKI KAISHA TOSHIBA, Tokyo (JP)

(72) Inventors: Jun Kano, Ome-shi (JP); Tatsuya Uehara, Akishima-shi (JP)

(73) Assignee: KABUSHIKI KAISHA TOSHIBA, Tokyo (JP)

(21) Appl. No.: 13/778,539

(22) Filed: Feb. 27, 2013

(30) Foreign Application Priority Data
Jun. 26, 2012 (JP) 2012-143383

(51) Int. Cl. H04N 21/454

(52) U.S. Cl. CPC H04N 21/4542
USPC 725/28

(57) ABSTRACT

According to one embodiment, an information output device includes an extractor, a receiver, and an output module. The extractor is configured to extract, from broadcast waves, identifying information related to on-air content. The receiver is configured to be capable of receiving, from an external service, relevant information related to the content using the identifying information as a search keyword. The output module is configured to output relevant information obtained by excluding information inappropriate as relevant information of the content from the relevant information provided from the external service by using filtering information. The filtering information is stored in a storage module and is for excluding the information inappropriate as the relevant information of the content from being output.

### CROSS-REFERENCE TO RELATED APPLICATIONS

This application is based upon and claims the benefit of priority from Japanese Patent Application No. 2012-143383, filed Jun. 26, 2012, the entire contents of which are incorporated herein by reference.

### FIELD

An embodiment described herein relates generally to an information output device, an information output method, and a computer program product.

### BACKGROUND

Along with the popularization of smartphones and tablet terminals in recent years, an increasing number of users use the smartphones or the tablet terminals while viewing broadcast programs . With such a trend, it is attempted to display, on the smartphones or tablet terminals, information coupled to the programs users are currently viewing. The information displayed by being linked to the programs, which is not limited to information relating to the broadcast programs, includes information relating to commercial messages (also abbreviated as CMs).

Information transmitted from broadcasting stations may sometimes be not enough for information to be displayed because a data amount that can be included in broadcast waves is limited. Thus, it can be considered to complement the information by each device such as the smartphone or the tablet terminal using external services such as search engines, and to provide the complemented information to users as relevant information.

However, in the conventional technique, when information, which is not transmitted from the broadcasting stations, is provided to users as the relevant information, there is a possibility that information which is against the intention of the providers of the programs or CMs may be provided to the users as the relevant information.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a network environment according to an embodiment;

FIG. 2 is an exemplary block diagram of a major signal processing system of a television broadcast receiver in the embodiment;

FIG. 3 is an exemplary schematic diagram of a configuration realized by an information output application of the television broadcast receiver and a configuration realized in a tablet terminal in the embodiment;

FIG. 4 is an exemplary schematic diagram of broadcast information extracted by a broadcast information extractor in the embodiment;

FIG. 5 is an exemplary schematic diagram of a table configuration of a filtering dictionary database 301 provided for an automotive cluster in the embodiment;

FIG. 6 is an exemplary schematic diagram of the table configuration of the filtering dictionary database 301 provided for a beer cluster in the embodiment;

FIG. 7 is an exemplary schematic diagram of relevant information displayed by the tablet terminal out of the relevant information received from a search engine in the embodiment;

FIG. 8 is an exemplary flowchart of a processing for outputting the relevant information by the television broadcast receiver in the embodiment; and

FIG. 9 is an exemplary flowchart of a processing for producing a filtering rule by a filtering rule generator in the embodiment.

### DETAILED DESCRIPTION

In general, according to one embodiment, an information output device comprises an extractor, a receiver, and an output module. The extractor is configured to extract, from broadcast waves, identifying information related to on-air content. The receiver is configured to be capable of receiving, from an external service, relevant information related to the content using the identifying information as a search keyword. The output module is configured to output relevant information obtained by excluding information inappropriate as relevant information of the content from the relevant information provided from the external service by using filtering information, the filtering information being stored in a storage module and being for excluding the information inappropriate as the relevant information of the content from being output.

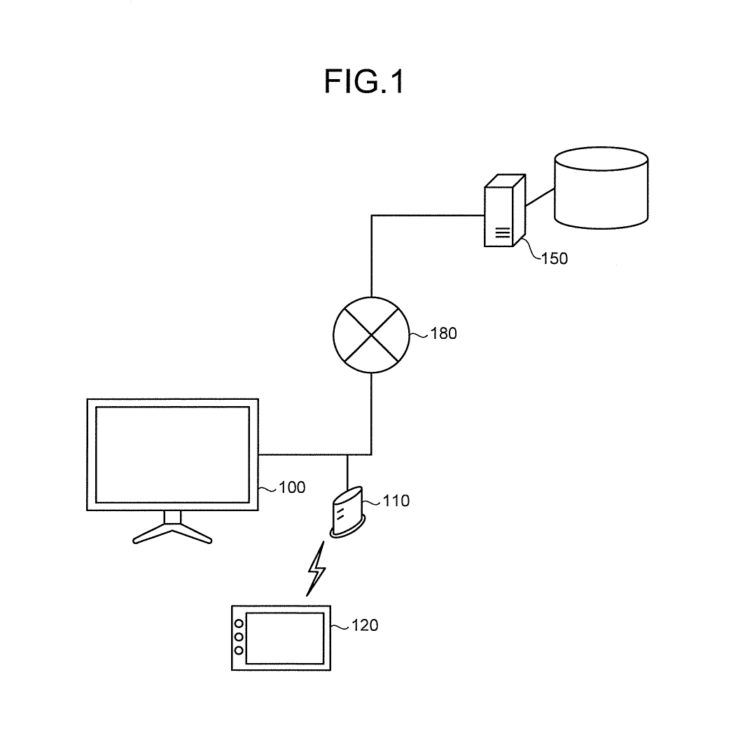

FIG. 1 is a schematic diagram illustrating an example of a network environment according to an embodiment. In the network environment illustrated in FIG. 1, a television broadcast receiver 100, a wireless communications adaptor 110, and a tablet terminal 120 are arranged in a home network (customer premises network).

The television broadcast receiver 100, which is connected to an antenna (not illustrated), reproduces content (e.g., programs or commercial messages (also abbreviated as CMs)) included in broadcast waves received through the antenna and stores therein the content, for example.

The television broadcast receiver 100 can exchange data between itself and a search engine 150 serving as an external service through a public network 180. The television broadcast receiver 100 transmits to the search engine 150 a search keyword produced on the basis of broadcast information extracted from the broadcast waves. As a result, the television broadcast receiver 100 receives search results by the search engine 150 as relevant information relating to an on-air program or CM.

In the embodiment, the broadcast information is defined as the information that relates to the on-air content, and is extracted from the broadcast waves.

The television broadcast receiver 100 can exchange data between itself and the tablet terminal 120 through the wireless communications adaptor 110. As a result, the television broadcast receiver 100 can provide the relevant information received from the search engine 150 to the tablet terminal 120.

The tablet terminal 120 may be configured to be able to connect to the television broadcast receiver 100. The tablet terminal 120 is not limited to a device capable of connecting to the television broadcast receiver 100, and may have a mobile communications function such as the third-generation (3G) communications. In the embodiment, an example is described in which the relevant information coupled to the program or CM displayed by the television broadcast receiver 100 is displayed on the tablet terminal 120. The output destination of the relevant information, however, is not limited to the tablet terminal 120. For example, the output destination of the relevant information may be a cell-phone terminal or a smartphone. The relevant information may be displayed by the television broadcast receiver 100.

When the television broadcast receiver 100 provides the relevant information to the tablet terminal 120, information that is not directly designated by broadcasting stations is provided to a user. In such a case, information against the intention of the broadcasting stations serving as primary providers of the broadcast waves and the sponsors of the programs or CMs may be provided as the relevant information. To address such possibility, the television broadcast receiver 100 according to the embodiment somewhat filters out the information to be provided to a user.

As a filtering technique, a method may be employed in which a dictionary (stop word dictionary) covering words included in sentences to be filtered out from the relevant information is embedded in the broadcast waves in relation to on-air programs or CMs. However, it is difficult to receive all information to be filtered through the broadcast waves from the broadcasting stations or sponsors. Therefore, in the embodiment, the television broadcast receiver 100 has a dictionary database for performing a filtering process.

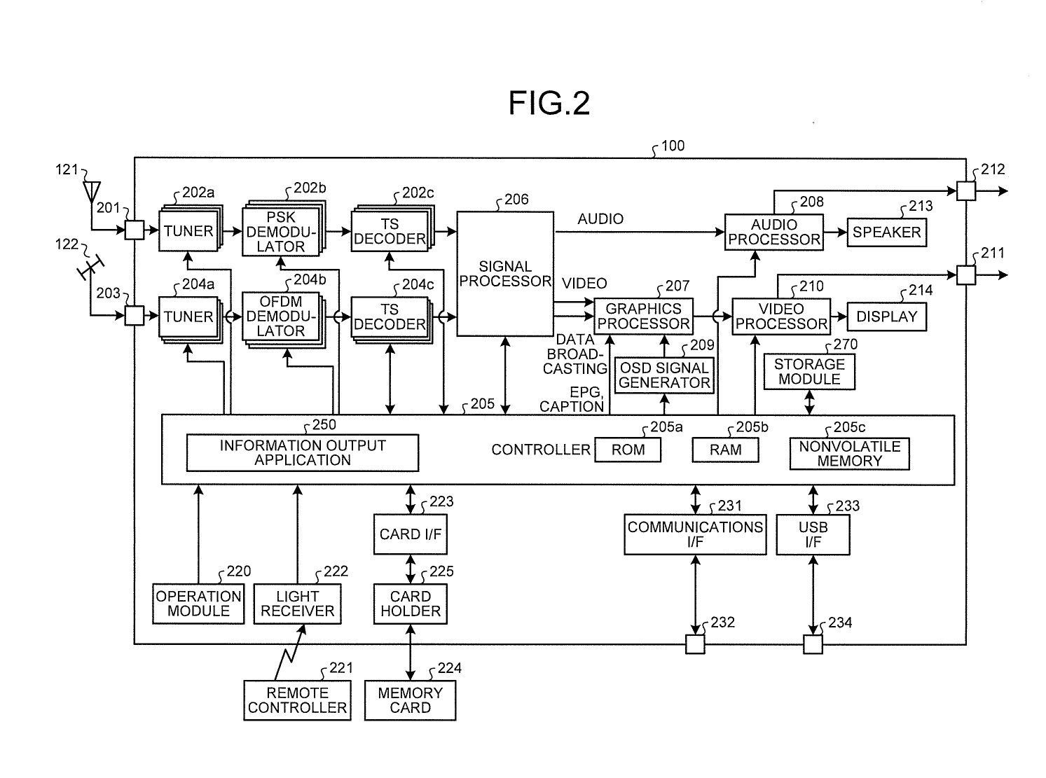

A hardware configuration of the television broadcast receiver 100 is described below. FIG. 2 is a block diagram illustrating a major signal processing system of the television broadcast receiver 100.

A satellite digital television broadcast signal received by an antenna 121 for broadcasting satellite/communication satellite (BS/CS) digital broadcast is supplied to a satellite digital broadcast tuner 202a through an input terminal 201.

The tuner 202a tunes into a desired channel by a control signal from a controller 205 to select a broadcast signal on the desired channel, and outputs the tuned broadcast signal to a phase shift keying (PSK) demodulator 202b.

The PSK demodulator 202b demodulates the broadcast signal tuned by the tuner 202a by the control signal from the controller 205, obtains a transport stream (TS) including a desired program, and outputs the TS to a TS decoder 202c.

The TS decoder 202c performs TS decoding processing on a transport stream (TS) multiplexed signal by the control signal from the controller 205 and outputs a packetized elementary stream (PES), which is obtained by de-packetizing the digital video and audio signals of the desired program, to a STD buffer (not illustrated) in a signal processor 206. The TS decoder 202c outputs section information sent from digital broadcasting to a section processor (not illustrated) in the signal processor 206.

A terrestrial digital television broadcast signal received by an antenna 122 for terrestrial broadcast is supplied to a terrestrial digital broadcast tuner 204a through an input terminal 203.

The tuner 204a can tune into a desired channel by the control signal from the controller 205 to select a broadcast signal of the desired channel. The tuner 204a outputs the tuned broadcast signal to an orthogonal frequency division multiplexing (OFDM) demodulator 204b.

The tuners 202a and 204a according to the embodiment receive multi-view video delivery signals providing a plurality of pieces of video information as the broadcast signals on channels through the antennae 121 and 122, respectively. The multi-view video delivery broadcast signals do not need to include all of the pieces of video information. For example, the video information may include only major video information while sub video information may include only address information of an acquisition destination.

The OFDM demodulator 204b demodulates the broadcast signal selected by the tuner 204a by the control signal from the controller 205, obtains the transport stream including a desired program, and outputs the TS to a TS decoder 204c.

The TS decoder 204c performs the TS decoding processing on the TS multiplexed signal by the control signal from the controller 205 and outputs the PES, which is obtained by de-packetizing the digital video and audio signals of the desired program, to the STD buffer in the signal processor 206. The TS decoder 204c outputs the section information sent from digital broadcasting to the section processor in the signal processor 206.

The signal processor 206 selectively performs predetermined digital signal processing on the digital video and audio signals supplied from the TS decoders 202c and 204c when a TV program is viewed and outputs the processed signals to a graphics processor 207 and an audio processor 208. When a program is recorded, the signal processor 206 performs predetermined digital signal processing on the digital video and audio signals supplied from the TS decoders 202c and 204c and stores the processed signals in a storage module 270 (e.g., a hard disk drive (HDD)) through the controller 205. When a recorded program is reproduced, the signal processor 206 performs predetermined digital signal processing on data of the recorded program read from the storage module 270 and outputs the processed data to the graphics processor 207 and the audio processor 208.

The controller 205 receives various types of data for obtaining the programs (e.g., key information for descrambling using BS conditional access system (B-CAS)), electronic program guide (EPG) information, program attribute information (e.g., program genres), and caption information (e.g., service information (SI) or program specific information (PSI)) from the signal processor 206. The controller 205 performs image generation processing on the basis of the input information for displaying the EPG or captions, and outputs the produced image information to the graphics processor 207.

The controller 205, which has functions to control recording of programs and programmed recording of programs, displays the EPG information on an external display device (e.g., a digital television receiver) and sets a programmed content input by a viewer through an operation module 220 or a remote controller 221 in a predetermined storage module when a program reservation is accepted. The controller 205 controls the tuners 202a and 204a, the PSK demodulator 202b, the OFDM demodulator 204b, the TS decoders 202c and 204c, and the signal processor 206 such that recording of the programmed program starts at the set time.

The section processor outputs to the controller 205 various types of data for obtaining the programs, the EPG information, the program attribute information (e.g., program genres), and the caption information (e.g., service information (SI) or program service information (PSI)) out of the section information input from the TS decoder 202c (204c).

The graphics processor 207 has a function to combine a digital video signal supplied from an AV decoder (not illustrated) in the signal processor 206, an on demand screen display (OSD) signal produced by an OSD signal generator 209, image data of data broadcasting, and the EPG and a caption signal generated by the controller 205, and to output the resulting data to a video processor 210.

When closed captions of closed-captioned broadcast are displayed, the graphics processor 207 superimposes closed caption information on a video signal on the basis of closed caption information controlled by the controller 205.

The digital video signal output from the graphics processor 207 is supplied to the video processor 210. The video processor 210 converts the input digital video signal into an analog video signal in a format that can be displayed on a display 214 or on an external device coupled through the output terminal 211, and outputs the analog video signal to the output terminal 211 or the display 214 to display the signal as an image.

The audio processor 208 converts an input digital audio signal into an analog audio signal in a format reproducible through a speaker 213 and outputs the analog audio signal to the speaker 213 or an external device coupled through an output terminal 212 to reproduce the signal as a sound.

The television broadcast receiver 100 overall controls all of the performances thereof including the above-described various receiving performances by the controller 205. The controller 205, which comprises a central processing unit (CPU), receives operation information from the operation module 220 or operation information sent from the remote controller 221 through a light receiver 222, and controls the respective components such that the operation contents are reflected.

In this case, the controller 205 mainly uses a read only memory (ROM) 205a, a random access memory (RAM) 205b that provides a working area for the CPU, and a nonvolatile memory 205c that stores therein various types of setting information and control information, for example.

The controller 205 is coupled through a card interface (I/F) 223 to a card holder 225 to which a memory card 224 is attachable. As a result, the controller 205 can transmit information through the card I/F 223 to the memory card 224 attached to the card holder 225.

The controller 205 is coupled to a local area network (LAN) terminal 232 through a communications I/F 231. As a result, the controller 205 can transmit information through the communications I/F 231 to a LAN compatible device connected to the LAN terminal 232.

The controller 205 is coupled to a universal serial bus (USB) terminal 234 through a USB I/F 233. As a result, the controller 205 can transmit information through the USB I/F 233 to various devices (e.g., an external hard disk drive) connected to the USB terminal 234.

The controller 205 of the television broadcast receiver 100 comprises an information output application 250. The CPU of the controller 205 reads the information output application 250, and realizes each component of the information output application 250 in the RAM 205b.

A configuration realized by the information output application 250 of the television broadcast receiver 100 and a configuration realized in the tablet terminal 120 are described below.

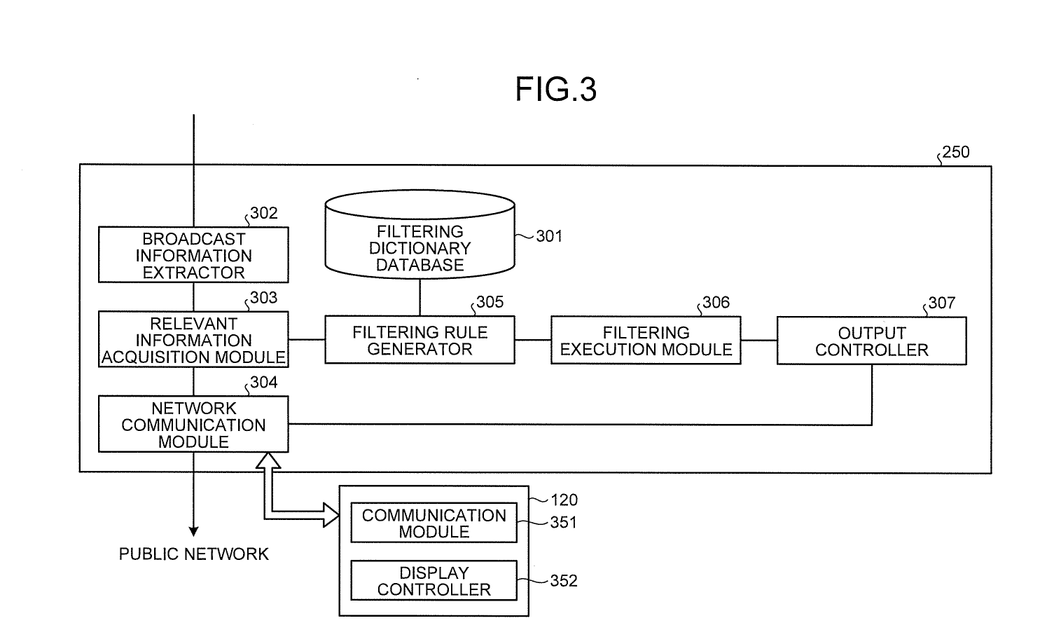

FIG. 3 is a schematic diagram illustrating the configuration realized by the information output application 250 of the television broadcast receiver 100 and the configuration realized in the tablet terminal 120.

As illustrated in FIG. 3, a filtering dictionary database 301, a broadcast information extractor 302, a relevant information acquisition module 303, a network communication module 304, a filtering rule generator 305, a filtering execution module 306, and an output controller 307 are realized by executing the information output application 250 in the television broadcast receiver 100. The filtering dictionary database 301 is preliminarily stored in the storage module 270 of the television broadcast receiver 100.

The broadcast information extractor 302 extracts the broad information related to on-air content from the broadcast waves received by the television broadcast receiver 100. In the embodiment, a case is described in which on-air content is a CM. The content, however, may be a program, for example.

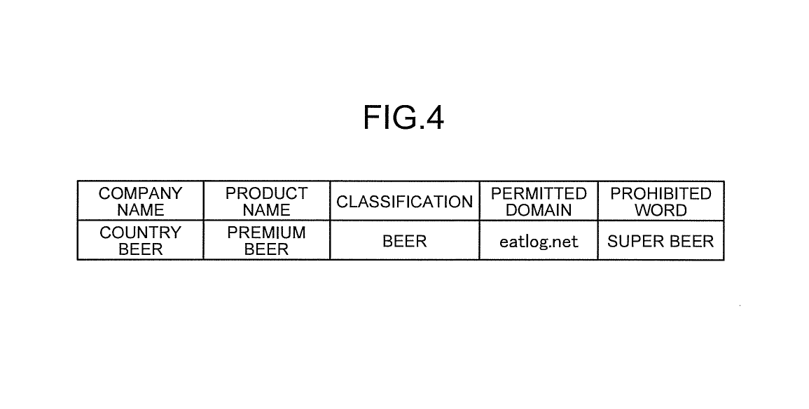

FIG. 4 is a schematic diagram illustrating an example of the broadcast information extracted by the broadcast information extractor 302. The example in FIG. 4 illustrates the broadcast information included in broadcast waves of a CM of beer of a beer company.

The broadcast information extracted by the broadcast information extractor 302 includes information that identifies a product (e.g., a product name) introduced by an on-air CM or information that identifies a company providing the CM (e.g., a company name). In addition, the extracted broadcast information includes a classification of the product. The classification of the product enables a type of business related to the content to be identified.

Furthermore, the broadcast information includes information set by the broadcasting station for controlling permission or prohibition of display as the relevant information. For example, the broadcast information includes a “permitted domain” that indicates a domain (uniform resource locator (URL)) to which access is permissible when the relevant information relating to a product or a company name is acquired. In the embodiment, access to the URLs under “eatlog.net” set as the “permitted domain” is permitted even when a keyword relating to another company in the same business field is included.

In addition, in the broadcast information, a “prohibited word” is specified that indicates a keyword for display prevention when the relevant information is acquired. As a result, in the acquired Web pages representing the relevant information, a Web site including “super beer” specified as the “prohibited word” is prevented from being provided to a user.

In the embodiment, the broadcast information is directly acquired from the broadcast waves. The acquisition destination of the broadcast waves, however, is not limited to the broadcast waves. For example, only a URL indicating the acquisition destination of the broadcast information may be included in the broadcast waves. In this case, the device such as the television broadcast receiver 100 can acquire the broadcast information by directly accessing the URL.

The filtering dictionary database 301 is referred to when a filtering rule is produced. In the filtering dictionary database 301 according to the embodiment, information relating to each company is collected for each type of business, for example.

As a result, information relating to other companies in the same business field in a certain type of business can be identified using the filtering dictionary database 301 out of the relevant information of companies or products provided from the search engine 150. Consequently, the embodiment enables the information inappropriate for being provided to a user to be identified.

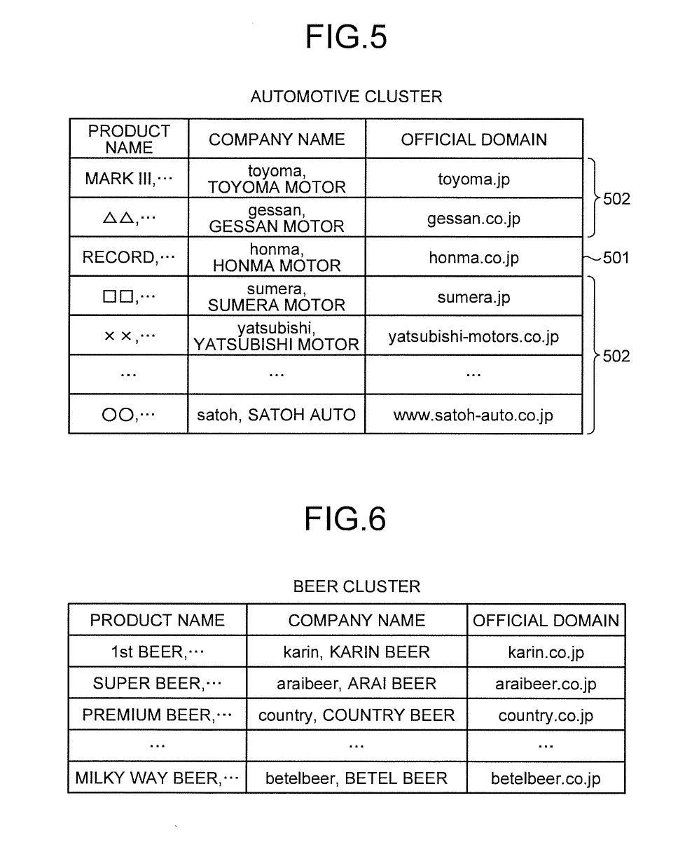

FIGS. 5 and 6 are schematic diagrams illustrating examples of a table configuration of the filtering dictionary database 301 provided for each type of business. FIG. 5 is a filtering dictionary database when the type of business is an automotive cluster. FIG. 6 is another filtering dictionary database when the type of business is a beer cluster. Although the table is provided for each type of business in the embodiment, the table is not limited to being provided for each type of business, and may be provided for each product classification or provided in accordance with another criterion.

In the examples illustrated in FIGS. 5 and 6, the product names, the company names, and the official domains of the respective companies or the products are stored in association with each other. As a result, for any company, products and official domains of other companies in the same business field can be identified. That is, in the embodiment, the products and official domains of the other companies are defined as information to be prevented from being output as the relevant information of any company.

In the example illustrated in FIG. 5, if the information relating to a record 501 in which the company name “Honma, Honma motor” and the product name “Record, . . . , ” are stored is included in an on-air CM, the information stored in a record group 502 in which the company names, product names, and official domains of other companies in the same business field are stored becomes information to be prevented from being output as the relevant information.

In the embodiment, the product names, company names, and official domains are stored in association with each other in the filtering dictionary database 301. Information to be stored so as to be in association with each other is not limited to the examples. Service names and relevant keywords may be registered so as to be in association with each other.

In the filtering dictionary database illustrated in the example of FIG. 5 or 6, the information that identifies an on-air product or company and the information to be excluded from being output as the relevant information are stored so as to be able to identify a corresponding relationship therebetween. As a result, the filtering rule generator 305 can produce, with reference to the filtering dictionary database 301, a filtering rule by which the company names or product names of the other companies in the same business field in the same type of business as that of the company name of the sponsor or the product name extracted by the broadcast information extractor 302 are excluded.

The network communication module 304 exchanges data between itself and an external service through the communications I/F 231. In addition, the network communication module 304 exchanges data between itself and the tablet terminal 120 through the communications I/F 231. An example of the external service is the search engine 150. The network communication module 304 can receive the relevant information relating to a search keyword by transmitting the search keyword to the search engine 150.

The network communication module 304 according to the embodiment transmits the information that identifies the company name or product name extracted by the broadcast information extractor 302 as the search keyword. Then, the network communication module 304 receives from the transmission destination of the search keyword the relevant information relating to the extracted product name or company name detected by the search keyword.

Although the external service is the search engine 150 in the embodiment, the external service may be another service providing system. Examples of the external service may include a blog service and a social network system (SNS).

The relevant information acquisition module 303 acquires the relevant information relating to the program or CM from the external service such as the search engine 150 through the network communication module 304 on the basis of the broadcast information extracted by the broadcast information extractor 302. An example of the relevant information is a Web page presenting various types of information such as product information, reputations, and feedbacks relating to the program or CM.

The filtering rule generator 305 produces a rule necessary for performing the filtering process on the basis of the broadcast information after referring to the filtering dictionary database 301.

The filtering rule generator 305, on the basis of the classification, company name, and product name included in the broadcast information, identifies the filtering dictionary database of the type of business corresponding to them. Thereafter, the filtering rule generator 305 acquires a list of the keywords to be excluded with reference to the identified filtering dictionary database, and produces a filtering rule for excluding the relevant information including the keywords.

For example, assuming that the company name of a sponsor included in the broadcast information extracted by the broadcast information extractor 302 is registered in a preliminarily classified (for each type of business) filtering dictionary database. The filtering rule generator 305 registers, with reference to the corresponding filtering dictionary database, the Web pages on the official domains of the other companies belonging to the same classification as that of the extracted sponsor as the filtering rule by which they are to be excluded.

As another example, official sites of different businesses are managed in the filtering dictionary database 301. Accordingly, a site that is not included in the filtering dictionary database 301 will be a site other than official sites of other companies in the same business field. Thus, the filtering dictionary database 301 may exclude a site including the product name or company name of the company in the same business field in the relevant information from a filtering target (a target to be excluded) if the site is not an official site of the company in the same business field.

In addition, the filtering rule generator 305 may exclude the relevant information including the company names or product names of the other companies in the same business field from the filtering target, if the permitted domain is included in the broadcast information and the relevant information is under the permitted domain.

The filtering execution module 306 applies the filtering rule produced by the filtering rule generator 305 to the relevant information acquired by the relevant information acquisition module 303, and executes the filtering process that excludes the information inappropriate as the relevant information.

The output controller 307 outputs, to the tablet terminal 120, the resulting relevant information after the inappropriate information is excluded by the filtering execution module 306 using the filtering dictionary database 301 out of the information acquired by the relevant information acquisition module 303 on the basis of the broadcast information.

In the embodiment, from among official sites (access information) stored in the filtering dictionary database 301, an official site that is not associated with the extracted company name or product name is excluded by the filtering execution module 306 as an official site of other company in the same business field. As a result, the output controller 307 can prevent the official sites of the other companies in the same business field from being output to the tablet terminal 120 as the relevant information.

In the embodiment, when a character string indicated by the prohibited words included in the broadcast information is included in the relevant information, the relevant information is excluded by the filtering execution module 306. As a result, the output controller 307 can prevent, on the basis of a “prohibited word” that can be included in the broadcast information extracted from the broadcast waves, the relevant information including the “prohibited word” from being output.

In the embodiment, the television broadcast receiver 100 thus configured can output the filtered relevant information to the tablet terminal 120.

The tablet terminal 120 is described below. The tablet terminal 120 executes a television cooperative application (not illustrated) for providing the relevant information supplied from the television broadcast receiver 100. As a result, the tablet terminal 120 achieves a communication module 351 and a display controller 352.

The communication module 351 exchanges data between itself and the television broadcast receiver 100. As a result, the communication module 351 receives the relevant information.

The display controller 352 controls display of data on a display (not illustrated) provided to the tablet terminal 120. The display controller 352 controls the display of the relevant information received by the communication module 351.

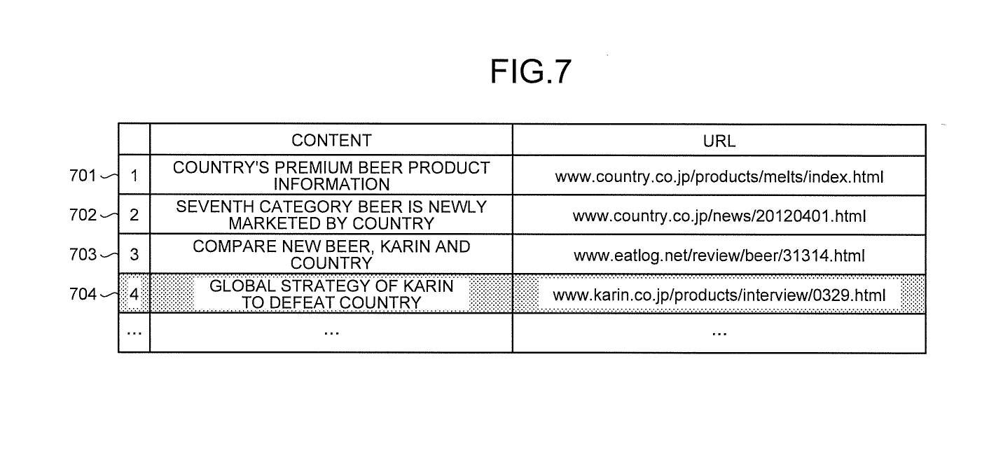

FIG. 7 is a schematic diagram illustrating an example of the relevant information displayed by the tablet terminal 120 out of the relevant information received from the search engine 150.

In the example illustrated in FIG. 7, the relevant information of records 701 to 703 is displayed while the relevant information of a record 704 is excluded by the filtering process. The broadcast information illustrated in FIG. 4 (company name “Country beer”, product name “premium beer”, and permitted domain “eatlog.net”) is extracted from the broadcast waves.

As a result, the relevant information indicated by the records 701 and 702, which include a portion or the whole of the product name or the company name extracted from the broadcast information and include no product names and company names of the other companies in the same business field, are displayed by the tablet terminal 120.

In addition, the relevant information indicated by the record 703, which includes a portion or the whole of the product name or the company name extracted from the broadcast information and also includes the product name and the company name of the other company in the same business field, is displayed by the tablet terminal 120 because the URL is under the permitted domain “eatlog.net”.

The relevant information indicated by the record 704, which includes a part or the whole of the product name or the company name extracted from the broadcast information and also includes the product name and the company name of the other company in the same business field, is excluded by the filtering execution module 306 because the URL is not under the permitted domain, and thus is not displayed by the tablet terminal 120.

In this way, in the embodiment, the relevant information following the intention of the sponsors of on-air CMs can be provided.

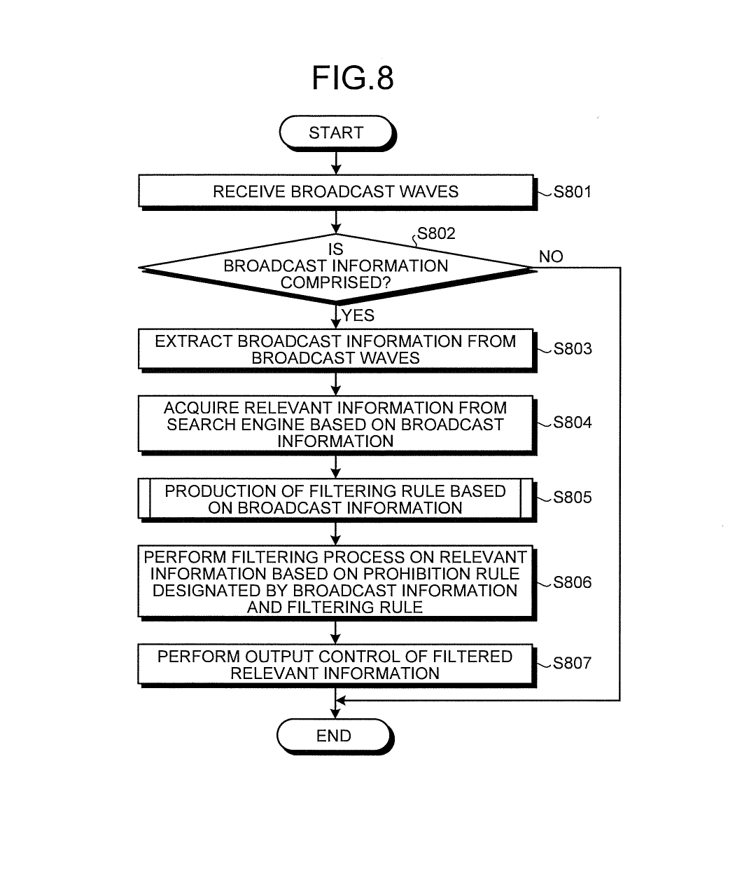

A processing for outputting the relevant information by the television broadcast receiver 100 according to the embodiment is described below. FIG. 8 is a flowchart illustrating the processing in the television broadcast receiver 100 according to the embodiment. The following processing is an example in which the relevant information is output to the tablet terminal 120 by a user's operation or automatic operation of the television broadcast receiver 100.

The television broadcast receiver 100 receives on-air broadcast waves (S801).

The broadcast information extractor 302 determines whether the broadcast information available for acquiring the relevant information is included in the received broadcast waves (S802). If the broadcast information extractor 302 determines that no available broadcast information is included (No at S802), the processing ends.

On the other hand, if the broadcast information extractor 302 determines that the available broadcast information is included (Yes at S802), the broadcast information extractor 302 extracts the broadcast information from the broadcast waves (S803). The extracted broadcast information is temporarily stored in the RAM 205b, for example.

The relevant information acquisition module 303 acquires the relevant information from an external service through the network communication module 304 using the product name or the company name included in the extracted broadcast information (S804). The search engine 150 is an example of the external service serving as the acquisition destination of the relevant information. The search keywords are sent to the search engine 150 and the relevant information can be acquired as the search results. Examples of the acquisition of the relevant information include a case where pages including the search keywords are acquired as the relevant information from new arrival information (what's new) of a blog site and another case where articles including the search keywords are acquired as the relevant information from articles in a news site.

The filtering rule generator 305 produces a filtering rule for excluding inappropriate information from the acquired relevant information on the basis of the extracted broadcast information (S805). The filtering rule is produced for the purpose of excluding information disadvantageous to the broadcasting stations and sponsors of the programs and CMs, who are the source of transmission of the broadcast information serving as bases for acquiring the relevant information. Because of this reason, in the embodiment, a certain filtering process is performed based on the rule produced with reference to permission/prohibition rules designated by a broadcast side and the filtering dictionary database 301 of the television broadcast receiver 100. A method of producing a filter is described later.

The filtering execution module 306 executes the filtering process on the relevant information acquired at S804 based on the filtering rule produced at S805 (S806). The filtering process described in the processing procedure above does not necessarily perform only the process of whether or not to display the information. For example, a scoring or ranking process such as an adjustment of the display order may be performed.

The output controller 307 outputs the filtered relevant information to the tablet terminal 120 (S807). As a result, the display controller 352 of the tablet terminal 120 displays the received relevant information to a user.

The procedure thus processed enables the relevant information from which the information against the intention of the sponsors of the programs or CMs has been excluded to be provided to a user.

In the television broadcast receiver 100 according to the embodiment, the keywords relating to the programs or CMs and the information of the domains indicating the official sites are acquired from the sponsors or broadcasting stations, and they are stored in the filtering dictionary database 301 in association with the information identifying the company or product. In the embodiment, the filtering dictionary database 301 is provided in the television broadcast receiver 100. The filtering dictionary database 301, however, may be provided in an external server.

In this way, the relevant information acquired from the search engine 150 is filtered in accordance with filtering information stored in the filtering dictionary database 301.

For example, when a CM of a newly-marketed beer is on the air, if the search engine 150 is searched simply using the keywords such as “beer” and “newly-marketed” and the search results are just provided to a user, information of new products of other companies in the same business field may also be displayed at a higher ranking.

In the television broadcast receiver 100 according to the embodiment, information of the companies in the beer business is preliminarily received from the broadcasting stations or makers of the television broadcast receiver 100, for example, and the received information is managed as the filtering dictionary database 301. When the relevant information of an on-air CM or program is displayed as the results searched by the search engine 150, the information relating to the other beer companies in the same business field is excluded. As a result, information such as the official home pages (HPs) of the competitors can be prevented from being displayed at a higher ranking.

The information of the competitors can be sent from the broadcasting station side for each program and CM. However, the amount of sending information increases and cumbersome procedures are required for preparing the information, which is impractical. In the embodiment, some dictionaries are preliminarily prepared for each type of business and each product genre, for example. This preparation can eliminate the cumbersome procedures and streamline the procedure.

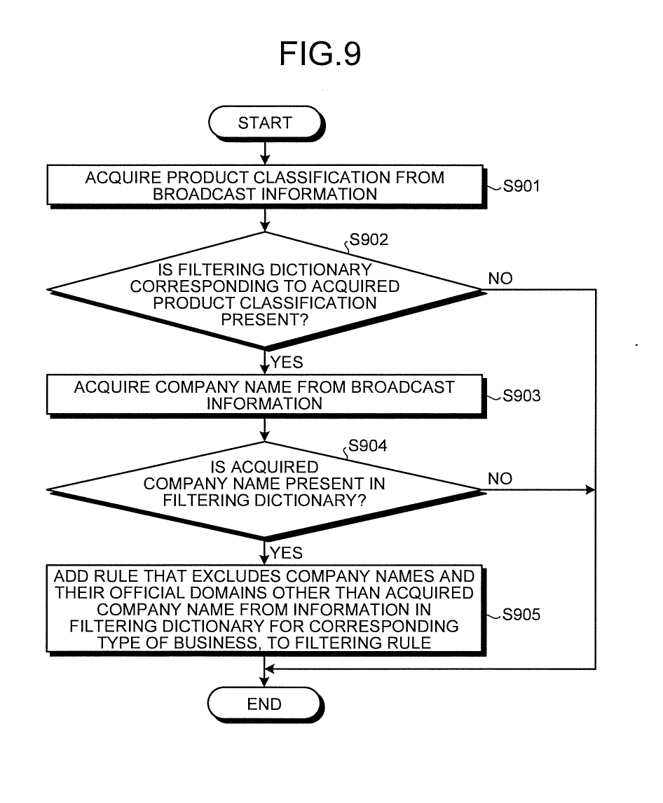

A procedure of when the filtering rule generator 305 produces a filtering rule is described below. FIG. 9 is a flowchart illustrating the processing for producing the filtering rule illustrated at S805 of FIG. 8 in the filtering rule generator 305 according to the embodiment.

The filtering rule generator 305 acquires classification information of the product from the broadcast information (S901). In the example illustrated in FIG. 4, “beer” corresponds to the classification information. The classification information indicates the overall product classification relating to the information displayed by the on-air program or CM.

The filtering rule generator 305 confirms whether the dictionary database corresponding to the acquired product classification is present in the filtering dictionary database 301 (S902). If the filtering rule generator 305 determines that no corresponding dictionary database is present (No at S902), the processing ends.

On the other hand, if the filtering rule generator 305 determines that the filtering dictionary database corresponding to the acquired product classification is present (Yes at S902), the filtering rule generator 305 acquires the company name providing the on-air program or CM from the broadcast information (S903). Although the company name providing the program or the CM is acquired in the embodiment, the product name may be acquired, for example.

The filtering rule generator 305 determines whether the acquired company name is registered in the filtering dictionary database corresponding to the acquired product classification (S904). If the filtering rule generator 305 determines that the acquired company name is not registered (No at S904), the processing ends.

On the other hand, if the filtering rule generator 305 determines that the acquired company name is registered in the filtering dictionary database corresponding to the acquired product classification (Yes at S904), the filtering rule generator 305 adds, to the filtering rule, the rule that excludes the company names (of the other companies in the same business field) other than the acquired company name and the information (e.g., the product names and official sites) associated with the company names (of the other companies in the same business field) in the filtering dictionary database corresponding to the product classification (S905).

The procedure thus processed enables the filtering rule filtering the information relating to the other companies in the same business field to be produced.

The procedure is specifically described below using the example illustrated in FIG. 7. In the example illustrated in FIG. 7, it is assumed that the broadcast information illustrated in FIG. 4 is extracted because the CM of the beer company is on the air in currently receiving broadcast waves. In this case, the relevant information acquisition module 303 acquires the relevant information indicated by the respective records of FIG. 7 using the broadcast information illustrated in FIG. 4.

Thereafter, the filtering rule generator 305 confirms whether the filtering dictionary database corresponding to the beer is present. When the filtering rule generator 305 confirms the presence of the filtering dictionary database corresponding to “beer”, the filtering rule generator 305 then confirms whether “Country beer”, which is the company name, is registered in the filtering dictionary database.

Because “Country beer” is registered in the filtering dictionary database illustrated in FIG. 6, the filtering rule generator 305 produces the filtering rule by which the information of the companies other than “Country beer” in the filtering dictionary database illustrated in FIG. 6 is excluded.

In the example illustrated in FIG. 6, the filtering rule is added such that the company names of “Karin”, “Araibeer”, and “Betelbeer”, and the product names and the URLs of the official domains associated with the these company names are excluded.

Then, the filtering execution module 306 performs a filtering process on the relevant information illustrated in FIG. 7 using the filtering rule produced by the above-described processing. The “Country's premium beer product information” in the record 701 is a target to be displayed as the information under the official domain because the URL includes “country.co.jp”

The “seventh category beer is newly marketed by Country” in the record 702 is a target to be displayed as the information under the official domain because of the URL likewise. The “compare new beer, Karin and Country” in the record 703 includes the information indicating the other company in the same business field “Karin”. The record 703, however, is excluded from the filtering target and is a target to be displayed because the URL includes the permitted domain “eatlog.net” provided from the broadcasting station side.

The “global strategy of Karin to defeat Country” in the record 704 is excluded as the filtering target because the URL is under the official domain of the other company in the same business field and the record 704 also includes the name of the other company in the same business field. The other records are also subjected to the same processing and thus the description thereof is omitted.

The television broadcast receiver 100 according to the embodiment can display the relevant information independently collected by the device while the intention of primary information providers is reflected by executing the above-described processing.

In the embodiment, the television broadcast receiver 100 is described as an example of a device that outputs the relevant information. The device that outputs the relevant information, however, is not limited to the television broadcast receiver 100, any device is applicable as long as the device can output the relevant information from input broadcast waves. For example, a DVD recorder is applicable.

The filtering dictionary database 301 may be periodically updated through the public network 180 in accordance with the changes in products provided by the respective companies, for example.

The configuration of the filtering dictionary database 301 is exemplarily described. The configuration is not limited to that of the filtering dictionary database 301. In the embodiment, the record is provided for each company. The record may be provided for each product.

In the embodiment, the television broadcast receiver 100 stores therein the filtering dictionary database and performs the filtering process with reference to the dictionary database. The storage of the dictionary database and the performing of the filtering process are not limited to being done by the same device. For example, the filtering dictionary database may be present in an external server and the device may inquire the external server of information based on the broadcast information extracted from the broadcast waves when receiving broadcast, and acquire the filtering rule.

In the embodiment, the filtering rule is applied to the relevant information after the relevant information is acquired from the external service. The filtering procedure, however, is not limited to such a technique, the search keywords may be preliminarily set such that the information designated by the filtering rule is excluded and thereafter the relevant information may be acquired from the external service.

In the embodiment, at least one of either the company name or the product name of the other company in the same business field is excluded by the filtering rule that excludes the information inappropriate for the relevant information of content from being output. The information to be excluded, however, is not limited to the company name and the product name of the other company in the same business field. For example, information that companies providing content may regard as inappropriate information is excluded, such as a name of a service provided by the other company in the same business field.

The acquisition of the relevant information and the filtering process may be individually performed by different devices . In the embodiment, it is assumed that a tablet terminal or a smartphone displays the final relevant information after being processed. The relevant information may be displayed by a device that receives broadcast (the television broadcast receiver 100 according to the embodiment).

The filtering dictionary database may be prepared as a large database standardized for various types of businesses. As another example of the filtering dictionary database, the broadcasting stations and the companies sponsoring the programs individually make an independent dictionary database such that they can somewhat control the display by themselves and information indicating the location of the dictionary database may be included in the broadcast information such that the device refers to the dictionary database.

As described above, the technique of the embodiment enables the content providers and the sponsors serving as the primary information providers to control also the relevant information independently collected by the device (e.g., the television broadcast receiver 100). As a result, a large number of settings of unnecessary prohibited words are not required, for example. In addition, the device can acquire the relevant information somewhat freely because the intention of the primary information providers can be reflected on the final display of the relevant information.

The technique described in the embodiment enables the relevant information based on the broadcast information acquired from the broadcast waves to be provided on the basis of a certain rule, thereby enabling the provision of information unintended by the broadcasting stations or sponsors to be prevented. In addition, the device can provide proper relevant information by reflecting the intention of the broadcasting stations or sponsors serving as the primary information providers while controlling how the relevant information is acquired and provided.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information output device comprising:
an extractor configured to extract, from broadcast waves, identifying information related to on-air content;
a receiver configured to be capable of receiving, from an external service, relevant information related to the content using the identifying information as a search keyword; and
an output module configured to output relevant information obtained by excluding information inappropriate as relevant information of the content from the relevant information provided from the external service by using filtering information, the filtering information being stored in a storage module and being for excluding the information inappropriate as the relevant information of the content from being output.

2. The information output device of claim 1, wherein, as the filtering information stored in the storage module, a corresponding relationship between the identifying information and information to be excluded from being output as the relevant information of the content identified by the identifying information is configured to be identifiably held.

3. The information output device of claim 2, wherein the filtering information stored in the storage module is configured to identifiably hold a corresponding relationship between identifying information identifying a first company or a first product and information to be excluded from being output as the relevant information of the content identified by the identifying information, the information to be excluded being related to a second company in a same business field as the first company or related to a second product of the same business field as the first product.

4. The information output device of claim 1, wherein
the filtering information stored in the storage module is configured to store therein identifying information identifying a first company or a first product and access information indicating an official site of the first company or the first product, in association with each other, and
the output module is configured to exclude, from among the access information stored in the filtering information, a site indicated by access information of a second company in a same business field as the first company from being output as the relevant information of the content indicated by the identifying information extracted by the extractor, the access information of the second company differing from the access information associated with the identifying information.

5. The information output device of claim 1, wherein,
in addition to extracting the identifying information, the extractor is configured to extract prohibited character string information to exclude outputting as the relevant information, and
the output module is configured to exclude the relevant information including the prohibited character string information extracted by the extractor from being output.

6. The information output device of claim 1, wherein
the receiver is configured to receive the relevant information related to the content from the external service, the received relevant information being detected if the identifying information is used as the search keyword,
the receiver further comprises a filtering execution module configured to exclude the information inappropriate as the relevant information of the content from the relevant information received by the receiver using the filtering information stored in the storage module, and
the output module is configured to output the relevant information received by the receiver after the information inappropriate as the relevant information of the content is excluded from the output relevant information by the filtering executing module.

7. The information output device of claim 1, wherein the extractor is configured to extract the identifying information related to an on-air program or commercial message, which is the on-air content.

8. An information output method performed by an information output device comprising a storage module configured to store therein filtering information for excluding, from relevant information of content provided from an external service, information inappropriate as relevant information of the content, the information output method comprising:
extracting, from broadcast waves, identifying information related to on-air content;
receiving, from the external service, the relevant information related to the content using the identifying information as a search keyword; and
outputting the relevant information received from the external service after the inappropriate information is excluded from the relevant information using the filtering information stored in the storage module.

9. A computer program product having a non-transitory computer readable medium including programmed instructions, wherein the instructions, when executed by a computer comprising a storage module configured to store filtering information for excluding, from relevant information of content provided form an external service, information inappropriate as relevant information of the content, cause the computer to perform:
extracting, from broadcast waves, identifying information related to on-air content;
receiving, from the external service, the relevant information related to the content using the identifying information as a search keyword; and
outputting the relevant information received from the external service after the inappropriate information is excluded from the relevant information using the filtering information stored in the storage module.
